(19) United States
(12) Patent Application Publication
(10) Pub. No.: US 2004/0177754 A1
(43) Pub. Date: Sep. 16, 2004

(54) Hc-shielding gas

(76) Inventors: Huglen Ostein, Hafrsfjord (NO); Vik Reidar, Hommersak (NO); Saanum Oivin, Stavanger (NO)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/480,946

(22) PCT Filed: May 31, 2002
(86) PCT No.: PCT/NO02/00191

(30) Foreign Application Priority Data
Jun. 19, 2001 (NO) 2001 3036

(51) Int. Cl. B01D 53/02

(52) U.S. Cl. 95/90

(57) ABSTRACT

Installation (1) for VOC-recovering and shielding gas protection of tanks (2) and connected devices on board a tanker, said installation comprising a first installation section (3) that normally is in operation for shielding gas protection and VOC-recovering and a second installation section (4) based on use of the inert gas (IG), which in substance is gaseous combustion product from the tanker's boilers/turbines and motors or gas from an inert gas generator, which second installation section functions as a back-up installation that normally is not in operation except for freeing the tanks (2) from gas. The first installation section is based on use of hydrocarbon (HC) gas and comprises: at least one VOC-recovering plant (5) connected to, at least one HC-storage (6) connected to, at least one HC-gas preparation device (7), devices for fluid communication (8) for HC-gas transport between the HC-storage and the tanks of the ship, devices (9,10) for fluid communication within the installation, internal on the ship and to/from an external installation (10), a control device (11) for operation of the installation according to pressure, volume, level, composition, temperature or flow within or through the components of the installation. A method making use of the above-mentioned installation is also a part of the invention.

### FIELD OF THE INVENTION

The present invention regards shielding gas protection of tanks on board a tanker. More specific the present invention regards an installation and a method for shielding gas protection of tanks and connected devices on board a tank ship, with which installation and method a minimized vaporization of volatile organic compounds (VOC) is achieved.

### PRIOR ART AND BACKGROUND OF THE INVENTION

Regarding operation of tankers it is essential to keep focus on the risk for fatal explosions, and how such are to be avoided. According to the International Maritime Organization (IMO) and the SOLAS-convention (SOLAS-Safety of Life at Sea) it is a requirement that a shielding gas system be mounted in form of an inert gas system in order to prevent fire and explosion in loading tanks. Further, it is required that the system be operated so that an explosive atmosphere never can be formed in the loading tanks' gas atmosphere during all tank operations the ship can undertake, such as load travel, ballast travel, tank washing, loading, unloading and gas purging/gas freeing. Normal practice as present is to use combustion product gas from the tanker's boilers/motors to keep the loading tanks inert, or make use of an inert gas generator. Said combusted gas is normally termed inert gas (IG) and has a typical content as follows: N₂: 83%, CO₂: 12%, O₂: 5%.

With respect to the danger for fire and explosion the IG-shielding gas is under-saturated, which means that its contents of hydrocarbons is too low for the gas to be explosive. The terms over-saturated and under-saturated have traditionally been used to term a gas mixture having too high or too low content of hydrocarbon components in order to be explosive, respectively. A pure hydrocarbon gas will be over-saturated with respect to danger of explosion, but by inflow of air such mixture can be diluted to an explosive gas mixture.

With the explosive content of hydrocarbons in such gas mixture, the oxygen content has to be kept below about 10% in order to avoid danger of explosion. For further information reference is made to the book Inert Gas Systems, International Maritime Organization (IMO), 1990.

Recently the focus on environment and careful exploitation of natural resources has increased. In this regard, since the middle of the 1980-ies, work has been undertaken to clarify the reasons for a systematic loss of load for example during buoy loading of oil. It has been found that a significant contribution to said loss is vapor of volatile organic components, termed VOC, that is let out to the atmosphere during loading. The inert gas that traditionally has been used for inerting the loading tanks during unloading contains a very low partial pressure of volatile organic components or VOC. Therefore an equilibrium saturation pressure will tend to be established in a natural way between the liquid hydrocarbons and the gas phase in a loading tank, with resulting intensive VOC-vaporization. It is in particular during loading, unloading and tank flushing by crude oil, whereby large gas volumes to where VOC can be vaporized exist, a great loss of VOC is taking place. The light components having high saturation vapor pressure, VOC, consist in substance of methane, ethane, propane, isobutane, n-butane, isopentane and n-pentane, and smaller amounts of heavier hydrocarbons (C₆⁺). From the Norwegian sector of the North Sea VOC is annually emitted in an amount corresponding to a large tanker fully loaded with oil. To illustrate the problem further it can be mentioned that a tanker of 140000 tons loading on the Statfjord field is estimated to loose an amount of hydrocarbon vapor that, if used as fuel on board the tanker, could be used to sail the ship to Rotterdam (about 2500 km) and back.

In some circumstances the above mentioned problem is reduced by using hydrocarbon gas as shielding gas (HC-shielding gas). In operation at present are floating production vessels having storage capacity, with pure HC-shielding gas in the storage tanks during normal operation and the traditional IG-shielding gas system as back-up.

HC-shielding gas or HC-gas means in this context a gas that in principle consists of light hydrocarbons. In principle pure VOC will accordingly be a HC-gas. VOC means in this context the vaporized light hydrocarbons in a mixture with significant content of other gases, or said hydrocarbons per se solved in a storage medium. The terms HC-gas and VOC will sometimes be used as synonyms to maintain a consistent terminology.

The problem with VOC-vaporization has been known for several years, but it has not been possible to find an acceptable solution for tankers or shuttle tankers. At present two prototype-VOC-recovery plants on shuttle tankers are in operation, but the shielding gas that is used in the tanks is the above-mentioned IG-shielding gas. Therefore the VOC-recovery plant is dimensioned for a large throughput of mixed IG-shielding gas and VOC-gas, with resulting large energy consumption, problems with effective operation because of varying mixture, large volume of IG-gas and presence of sulfur compounds, water vapor and ash from the combustion oil. The operation of the recovery plant is ineffective, and a pure IG/VOC-gas mixture can as such hardly be used on board the ship, and the plant is not in sufficient degree a closed system.

The challenge for tanker operation is in particular to provide supply of pure HC-gas when this is needed to maintain overpressure in the tanks and to recover the pure HC-gas when this has been displaced from the tanks, at the same time as the previously mentioned safety regulations never must be violated. So far no acceptable solution for using HC-gas as shielding gas on tankers has been found.

The objective of the invention is to provide an installation for VOC-recovery and shielding gas protection on board a tanker, which installation is without or in substance is without the above-mentioned limitations.

### SUMMARY OF THE INVENTION

With the present invention it is provided an installation for VOC-recovery and shielding gas protection of tanks and connected devices on board a tanker, said installation comprising a first section that normally is in operation for shielding gas protection and VOC-recovering, and a second installation section based on use of inert gas that in substance is gaseous combustion gas from the boiler of the tanker, turbines and motors, or gas from an inert gas generator, which second installation section is normally not in operation but functions as a back-up installation. The installation is distinguished in what appears from the characterizing clause of claim 1.

With the present invention it is also provided a method for VOC-recovering and shielding gas protection of tanks and connected devices on board a tanker, which method is distinguished in what appears from the characterizing clause of claim 5.

By using a pure HC-shielding gas on a tanker, in agreement with the present invention, it is achieved that the VOC-vaporization is reduced, the VOC-recovering plant becomes more effective since in substance pure HC-gas is sucked in and recovered, and collected VOC/HC can easier find use on board the ship, for example for energy production or propulsion machinery, or be exported to land. Further, the load handling system of the ship will be less filled with water vapor, amounts of sulfur components or ash from the combustion oil, whereby a significantly less corrosive atmosphere will be present.

In agreement with the present invention the ship will always maintain an overpressure of HC-gas as shielding gas in the tanks, except from gas freeing and optional ballast travel whereby the IG-installation section will be used. By never replacing HC-gas in the tanks with air, but with IG-gas which then optionally can be replaced with air, the safety regulations are met since an explosive gas mixture never will be present in the tanks.

### FIGURE

FIG. 1 illustrates an installation according to the invention for VOC-recovering and shielding gas protection on board a tanker.

### DETAILED DESCRIPTION

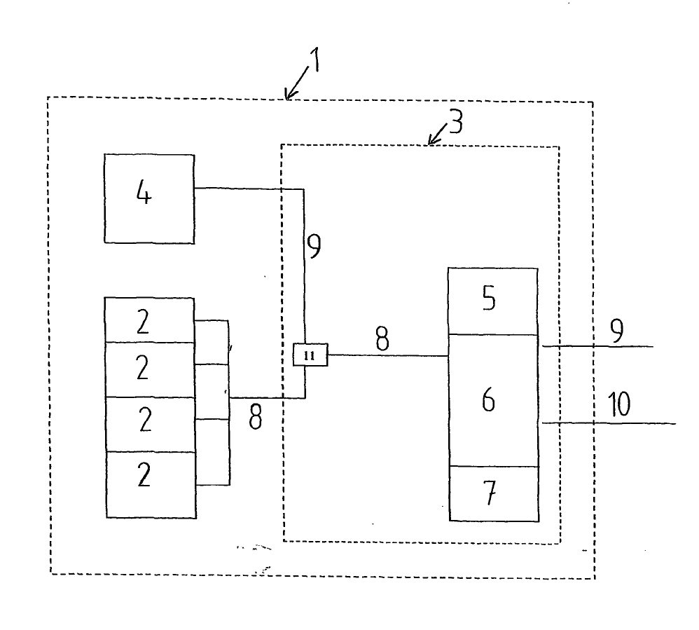

Reference is made to FIG. 1 illustrating the installation according to the invention. More specific an installation (1) according to the invention for VOC-recovering and shielding gas protection of tanks (2) and connected devices on board a tanker is illustrated, said installation comprising

a first installation section (3) that normally is in operation for shielding gas protection and VOC-recovering, and

a second installation section (4) based on use of inert gas (IG), which in substance is gaseous combustion product from the boiler of the tanker, turbines or motors or gas from an inert gas generator, which second installation section functions as a back-up installation that normally is not in operation except for freeing the tanks (2) for gas.

The installation according to the invention is distinguished in that the first installation section is based on use of hydrocarbon (HC) gas and is comprising:

at least one VOC-recovering plant (5) connected to

at least one VOC-storage (6) connected to

at least one HC gas preparation device (7)

devices for fluid communication (8) for HC gas transport between the HC storage and the tanks of the ship

devices (9, 10) for fluid communication within the installation, internal on the ship and to/from an external installation (10)

a control device (11) for operation of the installation according to pressure, volume, level, composition, temperature or flow within or through the components of the installation. In a preferred embodiment the VOC-recovering plant (5) comprises one or more of

an absorption plant that can conduct the vapor to the load

a condensing plant connected to the HC-storage

an adsorption plant, which handles the HC-gas and is passing it to the HC-storage.

In a preferred embodiment the HC-storage (6) is comprising one or more tanks equipped to handle oil particularly enriched in VOC, and/or one or more tanks containing condensed VOC (LPG).

High pressure is preferred in the HC-storage to hold more HC-gas and solve more HC-gas in the oil enriched on VOC.

With connected LNG- and/or LPG-tanks the composition of the HC-shielding gas can be adjusted to the VOC-vapor, whereby a composition of the HC-shielding gas can be achieved that will minimize VOC-vaporing for a given amount of HC-shielding gas.

Further, it is preferred that the HC-gas preparation device (7) both is comprising the crude oil washing guns of the ship and a gasifier (gasifier unit), of which the last mentioned preferably is connected to the HC-storage.

The gasifier can be used both during loading and unloading by passing at least a part of the oil flow through the gasifier, and HC-gas that is taken out is directed either to the HC-storage or to the tanks of the ship according to demand. It can be preferable to make use of both the crude oil washing guns and the gasifier at the same time, in particular during unloading.

Via the device (10) for fluid communication, in form of pipes, valves, etc., the equipment can receive refilling of HC-gas or fluid enriched in HC-gas, or deliver surplus thereof to an external unit, for example a field installation with a process plant.

The installation according to the invention is preferably designed to the same pressure class as the tanks of the ship, except for the HC-storage that most preferable is a high pressure unit.

The method according to the invention for shielding gas protection of tanks and connected devices on board a tanker, by use of the installation according to the invention, is distinguished in that it comprises: to maintain an overpressure of HC-shielding gas in the tanks of the tanker, by use of the first installation section, and to make use of the second installation section based on use of IG only as a back-up installation and during gas freeing, optionally also during ballast travel.

It is essential that overpressure of HC-shielding gas in the tanks of the ship never is replaced with air, but during gas freeing with IG-gas that again can be replaced with air, or be maintained with IG-gas at insufficient capacity for delivery of HC-gas from the HC-storage.

Further, it is preferred that low pressure or low level in the HC-storage results in the HC-preparation device being set in operation, for thereby to maintain the capability for delivery of HC-gas to shielding gas protection.

By unloading preferably a minimum number of tanks is empptied at the same time in order to limit the volume for which an overpressure of HC-shielding gas is to be maintained. At a predetermined low oil level in the tank during unloading, the crude oil washing guns are started, whereby HC-gas is produced while the tank is emptied. Adapted to demand for HC-gas the gasifier can be used, and HC-gas can be delivered from the HC-storage.

If an emptied tank is to be freed of gas, which means emptied for HC-gas, the HC-gas of the tank is passed on to another tank or is handled by the installation according to the invention, with controlled replacement of HC-gas with IG-gas during HC-recovering, followed by optional controlled replacement of IG-gas with atmospheric air.

Mixed IG-gas and HC-gas can optionally be passed to an external process unit via the pipe (10) for subsequent external VOC-recovering. This can be preferred for very large gas volumes.

1. Installation (1) for VOC-recovering and shielding gas protection of tanks (2) and connected devices on board a tanker, said installation comprising
a first installation section (3) that normally is in operation for shielding gas protection and VOC-recovering, and
a second installation section (4) based on use of inert gas (IG), which in substance is gaseous combustion product from the tanker's boilers, turbines and motors or gas from an inert gas generator, which second installation section functions as a back-up installation that normally is not in operation except for freeing the tanks (2) from gas, characterized in that the first installation section is based on use of hydrocarbon (HC) gas and is comprising:
at least one VOC-recovering plant (5) connected to
at least one HC-storage (6) connected to
at least one HC-gas preparation device (7)
devices for fluid communication (8) for HC-gas transport between the HC-storage and the tanks of the ship
devices (9, 10) for fluid communication within the installation, internal on the ship and to/from an external installation (10)
a control device (11) for operation of the installation according to pressure, volume, level, composition, temperature or flow within or through the components of the installation.

2. Installation according to claim 1, characterized in that the VOC-recovering plant (5) is comprising one or more of
an absorption plant that can pass vapor to the load
a condensation plant connected to the HC-storage
an adsorption plant with active coal and regeneration, handling the HC-gas and passing it to the HC-storage.

3. Installation according to claim 1, characterized in that the HC-storage (6) is comprising one or more high pressure tanks for HC-gas and oil particularly enriched in VOC, and one or more tanks containing LPG.

4. Installation according to claim 1, characterized in that the HC-gas preparation device (7) is comprising the crude oil washing guns of the ship and at least one gasifier (gasifier unit).

5. Method for shielding gas protection of tanks and connected devices on board a tanker, by use of the installation according to claim 1, characterized in that the method is comprising:
to maintain an overpressure of HC-shielding gas in the tanks of the tanker, by use of the first installation section, and
to use the second installation section based on use of IG only as a back-up installation and during freeing the tanks from gas, optionally also during ballast travel.

6. Method according to claim 1, characterized in that the overpressure of HC-shielding gas in the tanks of the ship never is replaced with air, but during gas freeing with IG-gas that again can be replaced with air, or is maintained with IG-gas at insufficient capability for delivery of HC-gas from the HC-storage.

7. Method according to claim 5 or 6, characterized in that low pressure or level in the HC-storage results in the HC-gas preparation device being set in operation.

8. Method according to claim 5, 6 or 7, characterized in that the connected LPG tanks are used both for HC-storage and to adjust the composition of HC-shielding gas to the composition of the VOC-vapor, whereby it is achieved a composition of the HC-shielding gas that will minimize the VOC-vaporing for a given amount of HC-shielding gas.
